(19) United States
(12) Patent Application Publication
(10) Pub. No.: US 2025/0371947 A1
(43) Pub. Date: Dec. 4, 2025

(54) SYSTEMS AND METHODS OF PLAYING A GAME OF CHANCE

(71) Applicant: Gagagamz, LLC, Cayucos, CA (US)

(72) Inventors: Sande STEWART, Cayucos, CA (US); Charles DiNolfi, Cayucos, CA (US)

(21) Appl. No.: 19/227,843

(22) Filed: Jun. 4, 2025

Related U.S. Application Data
(60) Provisional application No. 63/655,633, filed on Jun. 4, 2024.

(51) Int. Cl. G07F 17/32

(52) U.S. Cl. CPC G07F 17/3293

(57) ABSTRACT

A system and method for playing a game of chance includes randomizing a deck of playing cards. The method also includes receiving at least one SIDE BET wager from one or more players on at least one of the following: a) whether a sum of values of a plurality of subsequently revealed community cards will be over or under a predetermined break number; b) whether the sum of the values of the community cards will be exactly the predetermined break number; c) whether a predetermined number of the community cards will be red or black; d) whether the sum of the values of the community cards will be odd or even, or e) a combination of any of options a-d. The method also includes revealing the community cards from the deck and determining winners. The method may also include playing a poker game which includes no raising.

### CROSS-REFERENCE TO RELATED APPLICATIONS

The present application claims priority to U.S. Provisional Patent Application Ser. No. 63/655,663, filed Jun. 4, 2024 and entitled “Systems and Methods of Playing a Game of Chance,” the entirety of which is incorporated by reference herein.

### BACKGROUND OF THE DISCLOSURE

### 1. Field of the Disclosure

The present disclosure relates to games of chance. More particularly, the present disclosure relates to systems and methods of playing games of chance, such as poker-style games.

### 2. Related Art

This section provides background information related to the present disclosure which is not necessarily prior art.

Texas Hold'em, is one of the most popular and widely played forms of poker worldwide. That being said, in Texas Hold'em, the skills of betting, bluffing, raising, and reading your opponents are as, or more important than the cards in your hand. This leaves many casual poker players feeling intimidated and left out. It is also a game where players exit a hand pre-flop 80-90% of the time before the real action begins. There remains an opportunity for enhancements to gameplay of poker games with community cards which make more players feel comfortable and entertained while playing.

### SUMMARY OF THE DISCLOSURE

According to an aspect of the disclosure, a method for playing a game of chance includes randomizing a deck of playing cards. The method also includes presenting a plurality of SIDE BET indicia presenting betting options associated with at least two of: whether a sum of values of a plurality of subsequently received community cards will be over, under or exactly a predetermined break number, whether a predetermined number of the community cards will be red or black, and whether a sum of the values of the community cards will be odd or even. The method also includes receiving at least one SIDE BET wager from at least one of one or more players on at least one of the following: a) whether the sum of the values of the community cards will be over the predetermined break number; b) whether the sum of the values of the community cards will be under the predetermined break number; c) whether the sum of the values of the community cards will be exactly the predetermined break number; d) whether a predetermined number of the community cards will be red; e) whether a predetermined number of the community cards will be black; f) whether the sum of the values of the community cards will be an odd number; g) whether the sum of the values of the community cards will be an even number; h) a combination of any of options a-h. The method also includes revealing the community cards from the deck. The method also includes determining whether one or more of the players are winners based on the received SIDE BET wagers of the players, and paying the winners an amount associated with the SIDE BET wagers of the winners.

According to another aspect of the disclosure, a method for playing a game of chance includes randomizing a deck of playing cards. The method also includes receiving at least one SIDE BET wager from at least one of one or more players on at least one of the following: a) whether a sum of values of a plurality of subsequently revealed community cards will be over a predetermined break number; b) whether the sum of the values of the community cards will be under the predetermined break number; c) whether the sum of the values of the community cards will be exactly the predetermined break number; d) whether a predetermined number of the community cards will be red; e) whether a predetermined number of the community cards will be black; f) whether the sum of the values of the community cards will be an odd number; g) whether the sum of the values of the community cards will be an even number; h) a combination of any of options a-h. The method also includes revealing the community cards from the deck. The method also includes determining whether one or more of the players are winners based on the received SIDE BET wagers of the players, and paying the winners an amount associated with the SIDE BET wagers of the winners.

According to another aspect of the disclosure, the method further includes receiving a flop card wager from the one or more players. According to the example embodiments, the flop card wager is associated with a first group of the community cards associated with the poker game that are conventionally referred to as “the flop.” The method also includes distributing two random hole cards from the deck to all of the one or more players who placed a flop card wager. The method further includes receiving a predetermined turn card wager from all of the one or more players who wish to advance to revealing a turn card. The turn card is a community card that is revealed after the flop cards. Other numbers of cards could be associated with the turn card wager. The method also includes drawing and revealing a random turn card from the deck. The method also includes receiving a predetermined river card wager from all of the one or more players who wish to advance to revealing a river card. The river card is one of the community cards which is revealed after the turn card. Other numbers of cards could be associated with the river card wager. The method also includes drawing and revealing a random river card from the deck. The method also includes receiving a predetermined call wager from all of the one or more players who wish to reveal their hole cards and determine a winner. The method also includes determining which of the one or more players is a winner based on combinations of the one of the one or more players' respective hole cards, and the flop, turn and river cards, and paying the winner all of the flop, turn and river card wagers. According to another aspect of the disclosure, the winner is defined as the player of the one or more players who has the best poker hand according to pre-established hand rankings, e.g., high card, one pair, two pair, etc.

The systems and methods of the present disclosure provide simple, unintimidating, fast and entertaining manners of playing a game of chance. More particularly, unlike in traditional Texas Hold'em and similar community card games where most players fold before the flop cards are revealed, the subject systems and methods have a unique SIDE BET system which allows all players to participate in the reveal of community cards, like the flop cards in Texas Hold'em, during which they wager exclusively against other players, or against the house. Furthermore, during a poker segment of the game, betting may consist of exclusively adding wagers to a community pot to see the next community cards (e.g., turn and river cards), or folding without raising. Under this format, only the quality of a player's cards matters, thus providing an opportunity to participate against one another under generally traditional poker rules, but in a less intimidating manner.

### BRIEF DESCRIPTION OF THE DRAWINGS

These and other advantages of the present disclosure will be more readily understood by reference to the following description in combination with the accompanying drawings wherein:

FIG. 1 is a top view of a poker game arrangement on a game board which may be used with a game of chance, according to an aspect of the disclosure;

FIG. 2 is top view of a first embodiment of indicia on a game board for a SIDE BET game which may be used with the game of chance, according to an aspect of the disclosure;

FIG. 3 is a top view of a second embodiment of indicia on a game board for the SIDE BET game;

FIG. 4 is a top view of a third embodiment of indicia on a game board for the SIDE BET game;

FIG. 5 is a top view of a fifth embodiment of indicia on a game board for the SIDE BET game;

FIG. 6 is a top view of a sixth embodiment of indicia on a game board for the SIDE BET game;

FIG. 7 is a top view of a seventh embodiment of indicia on a game board for the SIDE BET game; and

FIG. 8 presents a flow diagram of a method of playing a game of chance according to an aspect of the disclosure.

### DETAILED DESCRIPTION OF THE ENABLING EMBODIMENTS

Example embodiments will now be described more fully with reference to the accompanying drawings. In general, the subject embodiments are directed to systems and methods of playing a game of chance. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

More particularly, referring to the figures, wherein like numerals indicate corresponding parts throughout the several views, embodiments of a system and method of playing a game of chance are provided. It should be appreciated that the systems and methods described herein may occur physically, e.g., at a gaming table at a casino or other establishment, or electronically, e.g., via a kiosk or user device like a smart phone or tablet. All components of the system and method may also be sold as a box set to permit users to play at any desired location. The box set may include items such as a deck of playing cards, instructions, betting chips, one or more game boards which present the indicia discussed herein, and the like.

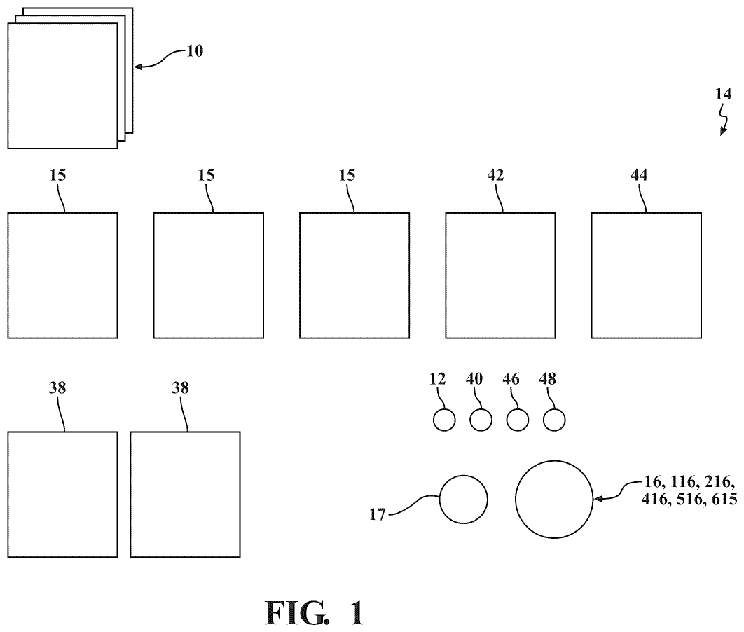

With initial reference to FIG. 1 and the flow diagram of FIG. 8, the method first includes 1000 randomizing a deck of playing cards 10, e.g., a standard 52 card deck. Other types and numbers of cards may be used. The method continues with 1002 receiving a primary game wager (e.g., a flop card wager), and/or 1004 receiving a SIDE BET wager(s) from each of the players. According to an embodiment, the flop card wager is part of a table-wide community pot and permits the player to participate in a community game, like a Texas Hold'em style poker game, and the SIDE BET wager permits the player to participate individually in a SIDE BET game against one another, or against the house (depending on the format selected by the house). According to the described embodiment, the poker game is a unique “Hold'em Lite” game which is similar to conventional Texas Hold'em, with some distinctions, as will be detailed below. The methods described herein could be incorporated into other games. For example, as will be discussed below, the SIDE BET wager may be used in association with other poker games and blackjack. If the player elects to participate in the poker game, they place a flop card wager of a predetermined value on a flop card wager indicia 12 on a game board 14. If the player elects to participate in the SIDE BET game, they place one or more SIDE BET wagers of a predetermined value on a SIDE BET indicia 16, 116, 216, 416, 516, 616 on the game board 14. As discussed below, the SIDE BET wagers are associated with various side bets that are associated with the community cards in the game at hand. In association with a poker game, these community cards may be the flop cards 15, or the flop cards 15 plus the river card 42 and turn card 44, or in a blackjack game, the community cards may include a player's two cards and the dealers initially revealed card. Other community cards associated with other games may be used. It should be appreciated that the wagers may be placed in a manner dependent on the style of board at hand, and whether the game is being played in person, electronically, or combinations thereof. For example, wagers may be placed by positioning physical chips on the various indicia on a physical game board, or by clicking a segment of a graphical user interface presenting the indicia in an electronic format.

According to embodiments, players may partake in the SIDE BET game associated with the SIDE BET wager without participating in the poker game, and vice versa; these requirements may be established by the house. According to embodiments, whether or not players elect to place a flop card wager prior to revealing the first group of community cards, e.g., the flop, the SIDE BET wager for the SIDE BET game remains in play. In an event in which all players elect to not place a flop card wager, the house may set rules as to whether the flop cards 15 should be dealt out with the SIDE BET wagers settled accordingly, or if the hand should end with all bets being pushed.

As will be further detailed below, after placing the wagers, the method continues with 1006 executing the SIDE BET game, 1008 executing the main game (e.g., the poker game), 1010 determining winners, and 1012 paying out the winners based on wagers.

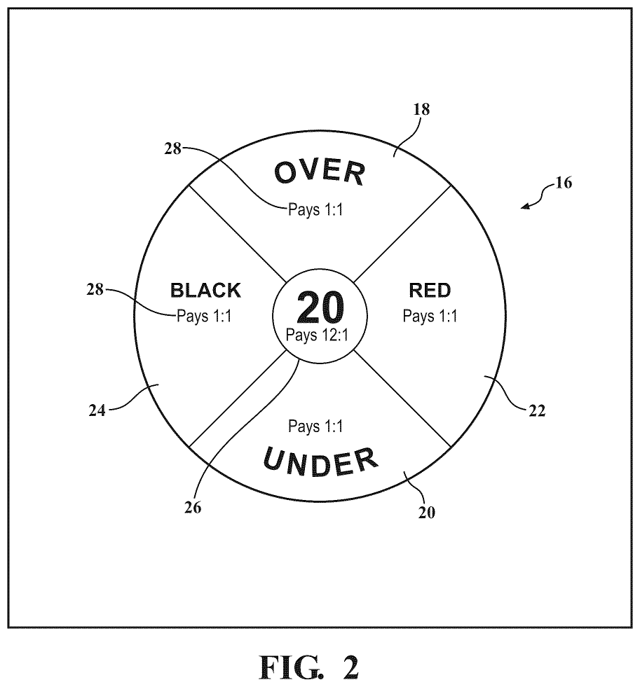

FIG. 2 presents a first embodiment of a SIDE BET indicia 16 which governs play of a first embodiment of the SIDE BET game. According to this and the subsequently described embodiments, each player may be presented with their own SIDE BET indicia 16 at a common game board 14, or at their own game board 14. The SIDE BET indicia 16 may be wheel-shaped and includes at least an over segment 18, an under segment 20, a red segment 22, a black segment 24, and a predetermined break number segment 26. During play, players may position their SIDE BET wager on any combination of the SIDE BET segments 18-26. All wagers discussed herein may be in the form of a physical or electronic chips or other forms of currency e.g., cash. The over, under and predetermined break number segments 18, 20, 26 allow the players to bet on whether a sum of the values of the three community cards 15 (e.g., flop cards 15) will be more than, less than, or exactly the break number. Conventional cards values may be used, or the house may employ variations, e.g., aces may have a value of 1 or 11, and all face cards may have a value of 10. According to this embodiment, three community cards 15 are used, consistent with the three flop cards of conventional Texas Hold'Em style poker.

According to this embodiment, the over segment 18 correlates with a wager that a sum of values the three community cards 15 will be over twenty, the under segment 20 correlates with a wager that a sum of the values of the community cards 15 will be under twenty, and the predetermined break number segment 26 correlates with a wager that a sum of the values of the community cards 15 will be exactly twenty. According to embodiments, the over/under betting may be played using more than just the three community cards 15 and/or the break number may be altered to a number other than twenty. For example, the break number may be a higher value, like 33, which may correlate with a sum of the values of five cards—the flop cards 15, the turn card 42 and the river card 44.

The red segment 22 correlates with a wager that two of the three community cards 15 will be red, and the black segment 24 correlates with a wager that two of the three community cards 15 will be black. Again, other numbers of community cards 15 may be used in association with the red and black segments 22, 24. For example the red segment 22 may correlate with a wager that three out of five community cards (e.g., the flop, turn and river cards 15, 42, 45) will be red.

As shown, pre-established odds 28 associated with each of the segments 18-26 are established, and may be presented on the SIDE BET indicia 16. According to the preferred embodiments, wagers on the over, under, black and red segments 18-24 pay at 1:1 odds, while wagers placed on the predetermined number segment 26 may pay at 4:1 odds. Other odds may be used as determined by the house for this and the subsequently described embodiments.

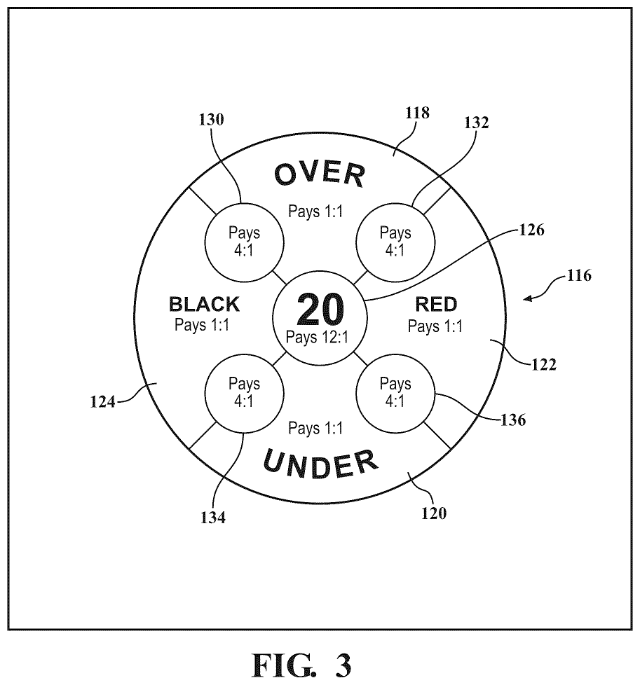

According to a second embodiment of the SIDE BET indicia 116 shown in FIG. 3, a number of combination segments 130, 132, 134, 136 may also be provided for permitting the players to wager on combinations of the over, under, red and black segments 118, 120, 122, 124. More particularly, a black/over segment 130 correlates with a wager that two of the community cards 15 will be black and a sum of the values of the community cards 15 will be over the break number. A red/over segment 132 correlates with a wager that two of the community cards 15 will be red and a sum of the values of the community cards 15 will be under the break number. A black/under segment 134 correlates with a wager that two of the community cards 15 will be black and a sum of the values of the community cards 15 will be under the break number, and a red/under segment 136 correlates with a wager that two of the community cards 15 will be red and a sum of the values of the community cards 15 will be under the break number. Again, pre-established odds associated with each of the combination segments 130, 132, 134, 136 are presented on the SIDE BET indicia 116. According to the preferred embodiments, the combination segments 130, 132, 134, 136 all pay at 12:1 odds, but other odds may be used as desired. The combination wagers have a lower likelihood of winning the wager than the individual bets, but provide a higher payout to players and a better betting margin for the house.

The SIDE BET wager may be placed on any of the segments 18-26, 30-36 of the SIDE BET indicia 16A, 16B. According to an embodiment, each player is required to place a SIDE BET wager on one of the over, under and predetermined number segments 18, 20, 26, and another wager on one of the red and black segments 22, 24. According to other embodiments, the players may be permitted to place SIDE BET wagers on any, or specific predetermined combinations of the SIDE BET segments 18-26, 30-36 of the SIDE BET indicia 16A, 16B.

At this point, the community cards 15 are revealed from the deck 10. It is then determined whether any of the players are winners based on the received SIDE BET wagers, after which the winners are announced and paid. The winners are paid based on the predetermined odds associated with the winning wager and the amount of the winning wager placed to end the SIDE BET game. The winnings may be paid in the form of physical or electronic currencies.

According to an embodiment, all wagers that are not determined to be winning wagers are considered a loss, which results in the player losing their SIDE BET wager, with two exceptions—1) if a player wagered on two of the community cards 15 to be red (via the red segment 22) and all three community cards 15 are red, this results in a push (i.e., the player gets their SIDE BET wager back), and 2) if a player wagered on two of the community cards 15 being black (via the black segment 24) and all three community cards 15 are black, the wager also results in a push. It should be appreciated that utilizing the push for the alike-colored three community cards 15 provides a margin for the house and increases drama/excitement during the reveal of the community cards, as the outcome of every color bet is not fully determined until the third of the community cards 15 is revealed. Furthermore, this margin allows the house to increase odds on other bets, thus making the other bets more enticing for participants. Finally, the fact that success of the SIDE BET game corresponds to both the sum of the values of the community cards 15 and whether a majority of the community cards 15 are red or black keeps players engaged and further contributes to overall excitement. It should be appreciated this same premise may be applied to other bets, such as whether two of three of the community cards are odd or even, or whether two of three community cards will be a single suit (discussed below). According to other embodiments, if all three community cards 15 are red or black, the bet may instead result in a loss instead of a push.

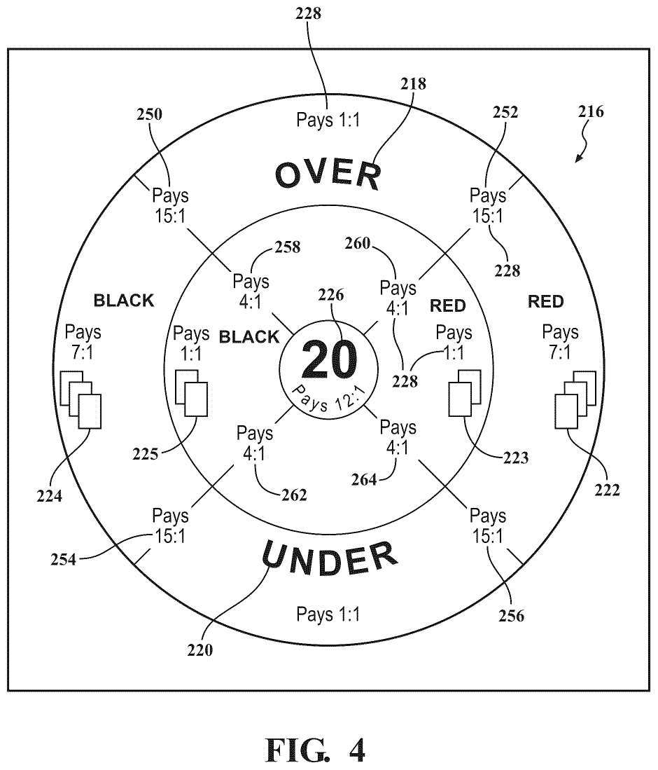

FIG. 4 presents a third embodiment of a SIDE BET indicia 216 that may be used in association with a third embodiment of the SIDE BET game. According to this embodiment, the SIDE BET indicia 216 includes a three card red segment 222, a two card red segment 223, a three card black segment 224, and a two card black segment 225. According to this embodiment, wagers placed on the three card red segment 222 encompass a wager that all three of the community cards 15 will be red, and wagers placed on the three card black segment 224 encompass a wager that all three of the community cards 15 will be black. Wagers placed on the two card red segment 223 and the two card black segment 225 are treated the same as those discussed in association with the first and second embodiments for the red and black segments 22, 24.

The SIDE BET indicia 216 also includes an over segment 218 associated with a wager that a sum of the values of the community cards 15 will be over a predetermined break number (e.g., 20 is shown) and an under segment 220 associated with a wager that a sum of the values of the community cards 15 will be under the break number. The game board 214 also includes a break number segment 226 for permitting a wager that the sum of the values of the community cards will be exactly the break number. Additional segments may be provided for other specific numbers.

The SIDE BET indicia 216 also has various combination segments, like a black/three card over segment 250, a red/three card over segment 252, a black/three card under segment 254, a red/three card under segment 256, a black/two card over segment 258, a red/two card over segment 260, a black/two card under segment 262, and a red/two card under segment 264, all corresponding with associated combination wagers. Odds 228 may be presented on the game board 214 for all of the aforementioned wagers.

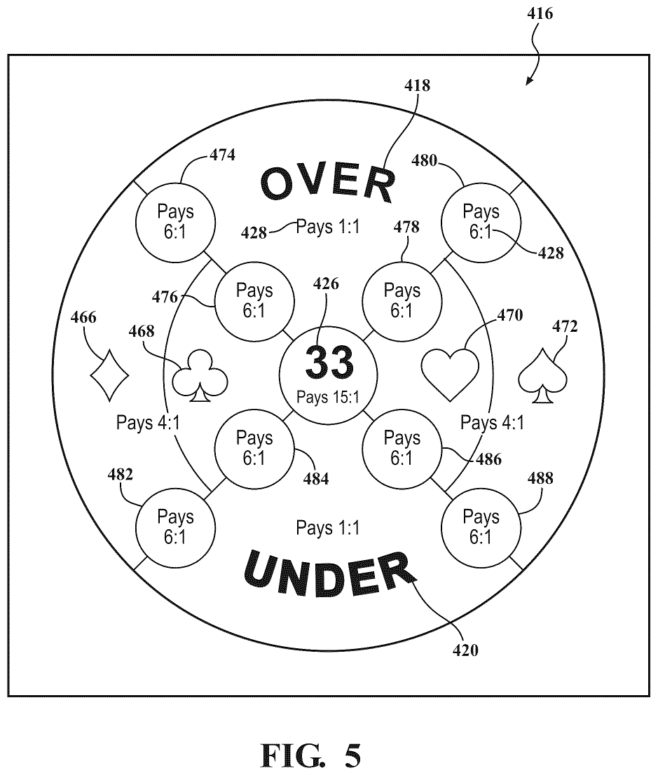

FIG. 5 presents a fifth embodiment of a SIDE BET indicia 416 which governs play of the SIDE BET game. As shown, the SIDE BET indicia 416 may include a plurality of suit segments 466, 468, 470, 472 for permitting a user to place a wager on a selected dominant (winning) suit. The suit segments 466, 468, 470, 472 include a diamonds segment 466, a clubs segment 468, a hearts segment 470 and a spades segment 472. If playing with the three community cards 15 alone, the dominant suit may be established if two or three of the revealed cards are the selected suit. If three different suits are revealed, the fourth (non-presented) suit may be declared the winner. If playing with all five cards 15, 42, 44, the player may wager on either three of the revealed cards being the same suit, or all four. In the instance in which the wager is placed on three of the cards being the same suit, the bet may be pushed if four of the cards are the same suit. If there are two pairs of cards of two different suits, the suit of the final card of a third suit can be declared the winner. If four or five cards of the same suit are revealed, the house may be declared a winner. As shown, the SIDE BET indicia 416 may also include an over segment 418 for permitting the players to place a wager that the sum of the values of the revealed community cards 15 will be over a predetermined break number 426, e.g., 33, as shown. The SIDE BET indicia 416 may also include an under segment 420 for permitting the players to place a wager that the sum of the values of the revealed community cards 15 will be under the predetermined break number 426. The SIDE BET indicia 416 also includes a series of combination segments 474-488 which permit the user to wager on combinations of a dominant suit and an over/under wager. The combination segments 474-488 include a diamonds/over segment 474, clubs/over segment 476, a hearts/over segment 478, a spades/over segment 480, a diamonds/under segment 482, a clubs/under segment 484, a hearts/under segment 486, and a spades/under segment 488 which each correlate with wagers associated with their named combinations. A series of odds 428 are presented on the SIDE BET indicia 416 to show betting odds associated with each wager.

According to any of the embodiments of the SIDE BET game discussed herein, winners may also be established after more than one event in the game. For example, winners may be established after the flop cards 15 are revealed, e.g., if two of three of the flop cards 15 are red. Additional winners may also be established after the turn and river cards 42, 44 are revealed, e.g., if three of the five total community cards 15, 42, 44 are red.

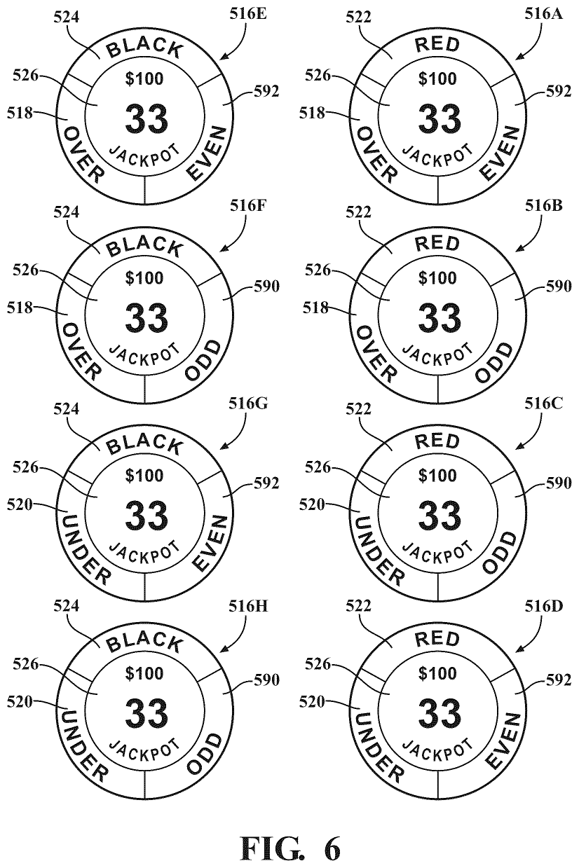

FIG. 6 presents a sixth embodiment of SIDE BET indicia 516A-H which governs play of the SIDE BET game. Of note, this embodiment also includes the opportunity to place a wager on a sum of the values of the community cards 15 being odd or even. Like the previously discussed embodiments, the SIDE BET game may be played in conjunction with any game which includes community cards, like poker and Blackjack. As shown, eight SIDE BET indicia 516A-H are provided in this embodiment. The SIDE BET indicia 516A-H have different arrangements of red segments 522, black segments 524, over segments 518, under segments 520, odd segments 590, even segments 592 and break number segments 526. During play, players that elect to participate in the SIDE BET game are randomly assigned one of the combination bets represented by the side bet indicia 516A-H. As detailed below, each SIDE BET indicia 516A-H includes a combination of three of the following predictions: 1) a majority red/black bet, 2) a sum of values odd/even bet, and 3) an over/under a predetermined break number bet.

More particularly, the SIDE BET indicia 516A-H include a red/even/over indicia 516A associated with a combination wager that a majority of the community cards (i.e., two of three of the community cards, or three of three of the community cards in the case in which three community cards 15 are used) will be red, a sum of the values of the community cards 15 will be even, and the sum of the values of the community cards 15 will be over the break number.

The SIDE BET indicia 516A-H also include a red/odd/over indicia 516B associated with a combination wager that a majority of the community cards 15 will be red, that the sum of the values of the community cards 15 will be odd, and the sum of the values of the community cards 15 will be over the break number.

The SIDE BET indicia 516A-H also include a red/odd/under indicia 516C associated with a combination wager that a majority of the community cards 15 will be red, the sum of the values of the community cards 15 will be odd, and the sum of the values of the community cards 15 will be under the break number.

The SIDE BET indicia 516A-H also include a red/even/under indicia 516D associated with a combination wager that a majority of the community cards 15 will be red, the sum of the values of the community cards 15 will be even, and the sum of the values of the community cards 15 will be under the break number.

The SIDE BET indicia 516A-H also include a black/even/over indicia 516E associated with a combination wager that a majority of the community cards 15 will be black, that the sum of the values of the community cards 15 will be even, and the sum of the values of the community cards 15 will be over the break number.

The SIDE BET indicia 516A-H also include a black/odd/over indicia 516F associated with a combination wager that a majority of the community cards 15 will be black, that the sum of the values of the community cards 15 will be odd, and the sum of the values of the community cards 15 will be over the break number.

The SIDE BET indicia 516A-H also include a black/odd/under indicia 516G associated with a combination wager that a majority of the community cards 15 will be black, that the sum of the values of the community cards 15 will be odd, and the sum of the values of the community cards 15 will be under the break number.

The SIDE BET indicia 516A-H also include a black/even/under indicia 516H associated with a combination wager that a majority of the community cards 15 will be black, that a sum of the values of the community cards 15 will be even, and the sum of the values of the community cards 15 will be under the break number.

According to an embodiment, given that there are eight potential SIDE BET combinations, up to eight players may partake in the SIDE BET game, with each player randomly assigned one of the bets represented by the SIDE BET indicia 516A-H. Furthermore, according to this embodiment SIDE BETS are pooled together in a pot, which at the conclusion of the game is distributed to the winner who satisfied all three elements in their SIDE BET wager, with the house taking a cut. According to another embodiment, the pot may be divided among players who satisfied two of three of the elements in their SIDE BET wager. According to these formats, players exclusively compete with one another, without competing against the house. Of note, this format fits under certain compliance requirements, requiring competition only among players. Under this format, a combination of all three elements is required to establish a winner. In an event in which there is not a winner in a given hand, the wagers may carry forward to the next hand and continue to do so until a winner is established. In each succeeding hand, only players who wagered in the original hand, where a win did not take place, are eligible to win the pot in a subsequent hand. A wager on a SIDE BET may be required by each player, but according to other embodiments, a wager on a SIDE BET is not required.

According to other embodiments, more than one wager may be placed on each SIDE BET indicia 516A-H, permitting more players to partake in the game. Also, according to embodiments, players may select which SIDE BET indicia 516A-H to place bets in association with. This format may be applied both if a community pot is used, in which the pot is split among winners, or if winnings are paid by the house according to pre-established odds.

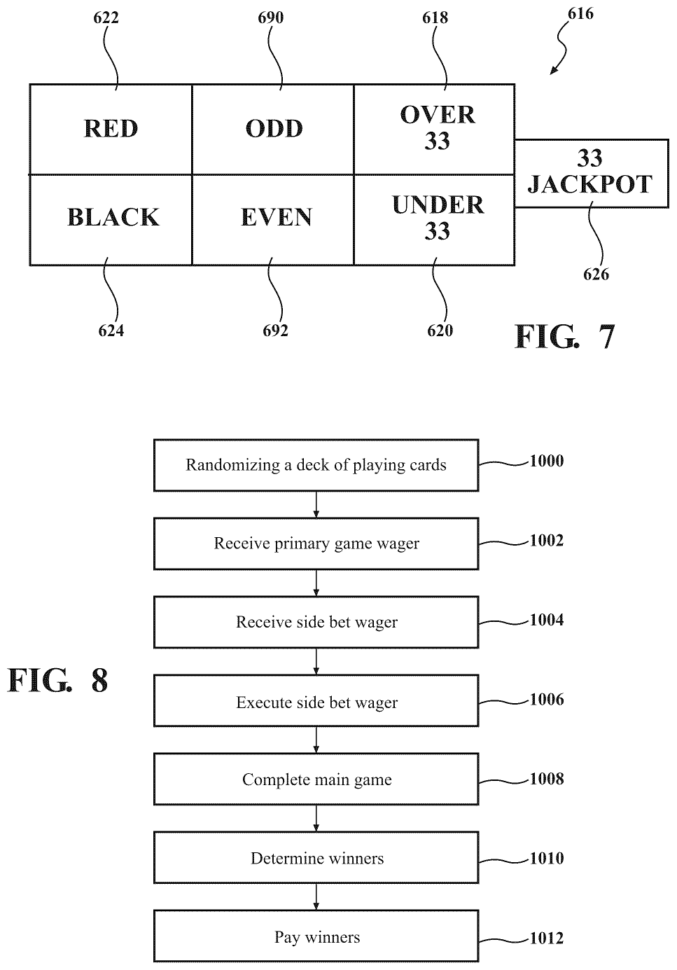

As shown in FIG. 7, according to another embodiment, instead of placing wagers on respective SIDE BET indicia 516A-H, each player may be presented with their own SIDE BET indicia 616 which presents the opportunity to build combinations of any of the elements discussed in the sixth embodiment via a single indicia 616. More particularly the SIDE BET indicia 616 includes a red segment 622, a black segments 624, an over segment 618, an under segment 620, an odd segment 690, and an even segment 692. The SIDE BET indicia 616 may also include a break number segments 626. According to this embodiment, any number of bets may be placed on each of the combinations by any number of the players. The pot may be split among winners. Alternatively, the winnings may be paid out by the house using predetermined odds.

According to another embodiment, a jackpot addition associated with the SIDE BET may be provided. Under this arrangement, a jackpot prize is distributed to all players that partake in the jackpot wager in a scenario in which a sum of the values of the community cards 15 is revealed to equal exactly the break number. Other arrangements may trigger the jackpot award. According to another embodiment, the jackpot may be awarded as an add-on to a hand following a hand in which the sum of the values of the community cards 15 is revealed to equal exactly the predetermined break number. For example, under this embodiment, if the SIDE BET game is played in association with a poker game, the winner of the poker hand may be awarded the jackpot. According to this embodiment, only players who placed a SIDE BET wager may be eligible for the jackpot, thus those who only play in the poker game without having placed a SIDE BET wager are not eligible, and the jackpot may be awarded to the best poker hand among those that placed a SIDE BET wager.

According to an embodiment, all players who place a SIDE BET wager are eligible for receiving the jackpot prize, and according to another embodiment, a respective jackpot bet is placed on a standalone JACKPOT indicia 17 (shown in FIG. 1), or the break number indicia 26, 126, 226, 426, 526, 626. Funding of the jackpot may take place in various ways. According to an embodiment, the house may take a cut of every SIDE BET wager to create a building jackpot. According to another embodiment, the house may offer a guaranteed jackpot that is kept in play until hit.

According to another embodiment, consistent with previous embodiments, players may be allowed to place individual wagers on any of the segments 518, 520, 522, 524, 526, 590, 592, 618, 620, 622, 624, 626, 690, 692 of the SIDE BET indicia 516A-H, 616 in the two previously described embodiments.

According to embodiments, after completion of the SIDE BET game, the method continues with the community game, like a poker game. According to embodiments, the community game described herein is a “Hold'em Lite” poker game which has similar rules to traditional Texas Hold'em based rules, but with an exception in that players strictly place a predetermined wager to advance through the flop, turn and river card and call portions of the game with no bet raising. The method includes distributing two hole cards 38 from the deck 10 to each of the plurality of players that placed a flop card wager. The hole cards 38 of each player remain privy to that specific player, i.e., they do not have to be shown to other players.

The method continues with each of the players placing a turn card wager of a predetermined value on a turn card wager indicia 40 (shown in FIG. 1) if they would like to advance to revealing a turn card 42. The turn card wager is introduced into the community pot with the flop card wager. If the player elects to not advance, they fold and lose their flop card wager. In other words, each player must decide if they are willing to put up the turn card wager to see the next community card 42. Again, the player is either in or out, with no raises. The method then continues with revealing the turn card from the deck.

After revealing the turn card 42, the method continues with each of the players placing a river card wager of a predetermined value on a river card wager indicia 46 if they would like to advance to revealing a river card 44. The river card wager is introduced into the community pot with the flop and turn card 15, 42 wagers. If the player elects to not advance, they fold and lose both their flop and turn card 15, 42 wagers. In other words, each player must decide if they are willing to put up the river card wager to see the river card 44. Again, the player is either in or out, with no raises. The method then continues with revealing the river card 44 from the deck.

The method then continues with each player placing a call wager of a predetermined value on a call wager indicia 48 if they would like to advance to the step of revealing all hole cards 38 and establishing winners of the poker game among the players. The call wager is introduced into the community pot with the flop, turn and river card 15, 42, 44 wagers. If the player elects to not advance, they fold and lose both their first, second and river card wagers. In other words, each player must decide if they are willing to put up the call wager to reveal all hole cards 38. Again, the player is either in or out, with no raises. It should be appreciated that all of the aforementioned wagers may be placed in manners other than placing a chip on a particular indicia. For example, a community pot may be utilized. Also, in an electronic format, wagers may be placed by selecting specific regions of a graphical user interface.

The method then continues with establishing a winner based on predetermined combinations of the hole, flop, turn and river cards 38, 15, 42, 44 for each player. The predetermined combinations may be based on conventional poker rules, or unique combinations may be established by the house. According to aspects, the winner is defined as the player who has the best poker hand according to pre-established hand rankings, e.g., high card, one pair, two pair, etc. The method continues with paying out the winner all of the first, second and river card wager from all of the players at the table. At this point, the house takes a predetermined rake from the winnings. The rake is determined by the house and may, at the operator's discretion, be passed on so that the game is played rake free. According to embodiments, operators may choose to forego a rake from the poker game and keep only proceeds from wagers from the SIDE BET game.

According to embodiments, tables/games may be designated by a specific dollar amount, e.g., $2 table/game, $3 table/game, $5 table/game, etc. The dollar amount may be the only amount that may be wagered for each of the predetermined wager amounts, with no raising permitted. According to other embodiments, different predetermined wagers may have different dollar amounts, e.g., the predetermined wager amount at the reveal of the flop cards may be $2 and the predetermined wager at the reveal of the turn card may be $3. In some embodiments, raises could be permitted at specific portions of the game based as determined by the house.

Similar to standard Texas Hold'em, a dealer button may be used to establish a dealer among the players during the poker game, with the dealer button being passed to the next player to the left after each poker hand. Other methods of dealing the cards may be used.

The aforementioned methods and systems may be played in physical/land-based casinos or other suitable establishments, or online. If played online, the revelations of all declarations may be simultaneous. Furthermore, the games may use real or virtual player funds, i.e., the game may be played for free or for non-monetary credits. The games may also be packaged and sold as a box set which includes all necessary components to play, e.g., a game board, instructions, playing cards, chips, etc.

It should be appreciated that the SIDE BET game may be played without interfering with any of the dynamics of the main poker game, and without adversely slowing down the main poker game. Furthermore, it should be appreciated that the SIDE BET game may be played with other card games. For example, with Blackjack, the three flop cards described above may be replaced by the two up cards presented to each player and the single up card placed in front of the dealer, or other combinations of cards used in the Blackjack game.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for playing a game of chance, comprising:
randomizing a deck of playing cards;
presenting a plurality of SIDE BET indicia presenting betting options associated with at least two of: whether a sum of a plurality of subsequently received community cards will be over, under or exactly a predetermined break number, whether a predetermined number of the community cards will be red or black, and whether a sum of the values of the community cards will be odd or even;
receiving at least one SIDE BET wager from one or players on at least one of the following:
a) whether a sum of a plurality of subsequently revealed community cards will be over a predetermined break number;
b) whether a sum of the game cards will be under the predetermined break number;
c) whether a sum of the community cards will be exactly the predetermined break number;
d) whether a predetermined number of the community cards will be red;
e) whether a predetermined number of the community cards will be black;
f) whether a sum of the values of the community cards will be an odd number;
g) whether a sum of the values of the community cards will be an even number;
h) a combination SIDE BET of any of options a-h;
revealing the community cards from the deck; and
determining whether any of the one or more players are winners based on the received SIDE BET wagers of the one or more players, and paying the winners an amount associated with the SIDE BET wagers of the winners.

2. The method as set forth in claim 1, wherein a combination side bet includes a combination of whether a predetermined number of the community cards will be red, whether the sum of the values of the community cards will be even, and whether a sum of the values of the community cards will be over the predetermined break number, and wherein the plurality of SIDE BET indicia further includes an red/even/over indicia presenting the option to bet on the predetermined number of the community cards being red, the sum of the values of the community cards being even, and the sum of the values of the community cards being over the predetermined break number.

3. The method as set forth in claim 1, wherein a combination side bet includes a combination of whether a predetermined number of the community cards will be red, whether the sum of the values of the community cards will be odd, and whether a sum of the values of the community cards will be over the predetermined break number, and wherein the plurality of SIDE BET indicia further includes an red/odd/over indicia presenting the option to bet on the predetermined number of the community cards being red, the sum of the values of the community cards being odd, and the sum of the values of the community cards being over the predetermined break number.

4. The method as set forth in claim 1, wherein a combination side bet includes a combination of whether a predetermined number of the community cards will be red, whether the sum of the values of the community cards will be odd, and whether the sum of the values of the community cards will be under the predetermined break number, and wherein the plurality of SIDE BET indicia further includes an red/odd/under indicia presenting the option to bet on the predetermined number of the community cards being red, the sum of the values of the community cards being odd, and the sum of the values of the community cards being under the predetermined break number.

5. The method as set forth in claim 1, wherein a combination side bet includes a combination of whether a predetermined number of the community cards will be red, whether a sum of the values of the community cards will be even, and whether the sum of the values of the community cards will be under the predetermined break number, and wherein the plurality of SIDE BET indicia further includes an red/even/under indicia presenting the option to bet on the predetermined number of the community cards being red, a sum of the values of the community cards being even, and the sum of the values of the community cards being under the predetermined break number.

6. The method as set forth in claim 1, wherein a combination side bet includes a combination of whether a predetermined number of the community cards will be black, whether the sum of the values of the community cards will be even, and whether the sum of the values of the community cards will be over the predetermined break number, and wherein the plurality of SIDE BET indicia further includes an black/even/over indicia presenting the option to bet on the predetermined number of the community cards being black, the sum of the values of the community cards being even, and the sum of the values of the community cards being over the predetermined break number.

7. The method as set forth in claim 1, wherein a combination side bet includes a combination of whether a predetermined number of the community cards will be black, whether the sum of the values of the community cards will be odd, and whether the sum of the values of the community cards will be over the predetermined break number, and wherein the plurality of SIDE BET indicia further includes an black/odd/over indicia presenting the option to bet on the predetermined number of the community cards being black, the sum of the values of the community cards being odd, and the sum of the values of the community cards being over the predetermined break number.

8. The method as set forth in claim 1, wherein a combination side bet includes a combination of whether a predetermined number of the community cards will be black, whether the sum of the values of the community cards will be odd, and whether the sum of the values of the community cards will be under the predetermined break number, and wherein the plurality of SIDE BET indicia further includes an black/odd/under indicia presenting the option to bet on the predetermined number of the community cards being black, the sum of the values of the community cards being odd, and the sum of the values of the community cards being under the predetermined break number.

9. The method as set forth in claim 1, wherein a combination side bet includes a combination of whether a predetermined number of the community cards will be black, whether the sum of the values of the community cards will be even, and whether the sum of the values of the community cards will be under the predetermined break number, and wherein the plurality of SIDE BET indicia further includes an black/even/under indicia presenting the option to bet on the predetermined number of the community cards being black, the sum of the values of the community cards being even, and the sum of the values of the community cards being under the predetermined break number.

10. The method as set forth in claim 1, wherein the subsequently received community cards include three randomly selected playing cards from the deck of playing cards.

11. The method as set forth in claim 10, wherein the predetermined break number is twenty.

12. The method as set forth in claim 10, wherein the predetermined number of community cards in evaluating whether the predetermined number of the community cards will be red or black is a majority of the community cards being the selected one of red or black.

13. The method as set forth in claim 1, wherein the combination side bet includes an option to bet on each of the following:
a) a combination of whether a predetermined number of the community cards will be red, whether the sum of the values of the community cards will be even, and whether the sum of the values of the community cards will be over the predetermined break number, and wherein the plurality of SIDE BET indicia further includes an red/even/over indicia presenting the option to bet on the predetermined number of the community cards being red, the sum of the values of the community cards being even, and the sum of the values of the community cards being over the predetermined break number;
b) a combination of whether a predetermined number of the community cards will be red, whether the sum of the values of the community cards will be odd, and whether the sum of the values of the community cards will be over the predetermined break number, and wherein the plurality of SIDE BET indicia further includes an red/odd/over indicia presenting the option to bet on the predetermined number of the community cards being red, the sum of the values of the community cards being odd, and the sum of the values of the community cards being over the predetermined break number;
c) a combination of whether a predetermined number of the community cards will be red, whether the sum of the values of the community cards will be odd, and whether the sum of the values of the community cards will be under the predetermined break number, and wherein the plurality of SIDE BET indicia further includes an red/odd/under indicia presenting the option to bet on the predetermined number of the community cards being red, the sum of the values of the community cards being odd, and the sum of the values of the community cards being under the predetermined break number;
d) a combination of whether a predetermined number of the community cards will be red, whether the sum of the values of the community cards will be even, and whether the whether the sum of the values of the community cards will be under the predetermined break number, and wherein the plurality of SIDE BET indicia further includes a red/even/under indicia presenting the option to bet on the predetermined number of the community cards being red, the sum of the values of the community cards being even, and the sum of the values of the community cards being under the predetermined break number;
e) a combination of whether a predetermined number of the community cards will be black, whether the sum of the values of the community cards will be even, and whether the sum of the values of the community cards will be over the predetermined break number, and wherein the plurality of SIDE BET indicia further includes an black/even/over indicia presenting the option to bet on the predetermined number of the community cards being black, the sum of the values of the community cards being even, and the sum of the values of the community cards being over the predetermined break number;
f) a combination of whether a predetermined number of the community cards will be black, whether the sum of the values of the community cards will be odd, and whether the sum of the values of the community cards will be over the predetermined break number, and wherein the plurality of SIDE BET indicia further includes an black/odd/over indicia presenting the option to bet on the predetermined number of the community cards being black, the sum of the values of the community cards being odd, and the sum of the values of the community cards being over the predetermined break number;
g) a combination of whether a predetermined number of the community cards will be black, whether the sum of the values of the community cards will be odd, and whether the sum of the values of the community cards will be under the predetermined break number, and wherein the plurality of SIDE BET indicia further includes an black/odd/under indicia presenting the option to bet on the predetermined number of the community cards being black, the sum of the values of the community cards being odd, and the sum of the values of the community cards being under the predetermined break number; and
h) a combination of whether a predetermined number of the community cards will be black, whether the sum of the values of the community cards will be even, and whether the sum of values of the community cards will be under the predetermined break number, and wherein the plurality of SIDE BET indicia further includes an black/even/under indicia presenting the option to bet on the predetermined number of the community cards being black, the sum of the values of the community cards being even, and the sum of the values of the community cards being under the predetermined break number.

14. The method as set forth in claim 13, wherein each player is required to place a combination SIDE BET associated with one of the red/even/over indicia, the red/odd/over indicia, the red/odd/under indicia, the red/even/under indicia, the black/even/over indicia, the black/odd/over indicia, the black/odd/under indicia, and the black/even/under indicia.

15. The method as set forth in claim 14, wherein only a single combination SIDE BET may be placed in association with each of the red/even/over indicia, the red/odd/over indicia, the red/odd/under indicia, the red/even/under indicia, the black/even/over indicia, the black/odd/over indicia, the black/odd/under indicia, and the black/even/under indicia.

16. The method as set forth in claim 13, wherein the winners are paid at predetermined odds associated with the placed SIDE BETS.

17. The method as set forth in claim 13, wherein the SIDE BETS are contributed to a pool, and winners are paid from the pool.

18. The method as set forth in claim 1, further including presenting at least one flop card indicia, a turn card indicia, a river card indicia, and a call indicia;
receiving a flop card wager from the one of more players by the one or more players positioning bets on the at least one flop card indicia;
distributing two random hole cards from the deck to the one or more players who placed a flop card wager;
receiving a predetermined turn card wager from the one or more players who elect to advance to revealing a turn card by the one or more players positioning bets on the at least one turn card indicia;
drawing and revealing a random turn card from the deck;
receiving a predetermined river card wager from the one or more players who elect to advance to revealing a river card by the one or more players positioning bets on the at least one river card indicia;
drawing and revealing a random river card from the deck;
receiving a call wager from the one or more players who wish to reveal all hole cards and establish a winner by the one or more players positioning bets on the at least one call wager; and
determining which of the one or more players is a winner based on combinations of the player of the one or more players respective hole cards, and the first, second and river cards, and paying the winner.

19. The method as set forth in claim 1, wherein the deck of playing cards is a standard 52 card deck of playing cards.

20. A method for playing a game of chance, comprising:
randomizing a deck of playing cards;
receiving at least one SIDE BET wager from one or players on at least one of the following:
a) whether a sum of values of the community cards will be over a predetermined break number;
b) whether the sum of the values of the community cards will be under the predetermined break number;
c) whether the sum of the community cards will be exactly the predetermined break number;
d) whether a predetermined number of the community cards will be red;
e) whether a predetermined number of the community cards will be black;
f) whether the sum of the values of the community cards will be an odd number;
g) whether the sum of the values of the community cards will be an even number;
h) a combination SIDE BET of any of options a-h;
revealing the community cards from the deck; and
determining whether any of the one or more players are winners based on the received SIDE BET wagers of the one or more players, and paying the winners an amount associated with the SIDE BET wagers of the winners.
